(19) United States
(12) Patent Application Publication
(10) Pub. No.: US 2023/0166915 A1
(43) Pub. Date: Jun. 1, 2023

(54) SINGULATING CONVEYOR WITH DIFFERENT SPEED ZONES IN A HERRINGBONE PATTERN AND METHOD OF OPERATION THEREOF

(71) Applicant: ROACH MANUFACTURING CORPORATION, Trumann, AR (US)

(72) Inventors: Michael R. PARKS, Trumann, AR (US); Eddie Joe MOODY, Trumann, AR (US)

(73) Assignee: ROACH MANUFACTURING CORPORATION, Trumann, AR (US)

(21) Appl. No.: 17/982,884

(22) Filed: Nov. 8, 2022

Related U.S. Application Data
(60) Provisional application No. 63/281,283, filed on Nov. 19, 2021.

(51) Int. Cl. B65G 13/07; B65G 13/071; B65G 47/31

(52) U.S. Cl. CPC B65G 13/07; B65G 13/071; B65G 47/31

(57) ABSTRACT

A singulating conveyor having a herringbone pattern includes transporting rollers extending from the entry end to the exit end. The rollers are divided into four longitudinal zones, and each longitudinal zone is divided into a pair of side-by-side complementary outside and inside lateral zones. The rollers of each of the eight lateral zones are driven by a separate motor and V-Belt drive system that can be operated at differing speeds. The speed of the transporting rollers in the four longitudinal zones increases successively from the longitudinal zone adjacent the conveyor entry end towards the longitudinal zone having the discharge rollers, and the speed of the rollers of the outside lateral zones operate at higher speeds than the rollers of the adjacent inside lateral zones. Some of the rollers in the outside lateral zones preferably have higher coefficients of friction than the rollers of adjacent inside lateral zones.

### CROSS REFERENCE TO RELATED APPLICATIONS

This application claims priority back to U.S. Provisional Pat. Application Serial No. 63/281,283, filed Nov. 19, 2021.

### BACKGROUND OF THE INVENTION

### 1. Field of the Invention

This invention relates to singulating conveyors, and their method of operation, which conveyors can receive multiple packages, containers and parcels (hereinafter collectively “parcels”) in a random flow at one location adjacent the conveyor’s entry end and transport the packages to a second location while at the same time organizing the parcels to exit in a single file at the conveyor’s exit end.

2. Description of the Related Art Conveyors are conventionally used to convey or transport items such as parcels of product in warehouses, manufacturing facilities and other locations. Typically, such facilities employ a conveyor distribution system that receives the parcels in a random flow for transport to a different location within the facility or location. However, it is desirable at some point during the conveyor distribution system to align the parcels into a single file for individual handling. Such alignment often is done by hand by workers at the facility, standing alongside at a convenient location or locations adjacent one or more conveyors.

More recently, singulating conveyors have been introduced into the marketplace in order to reduce the necessity for or number of workers to place the parcels in a desirable single file. One singulating conveyor has been marketed by Roach Manufacturing Corporation of Trumann, Arkansas (hereinafter “Roach”) under the trademark “Gator”. A copy of the Roach brochure directed to its “Gator” conveyor was submitted as part of the aforesaid U.S. Provisional Application for Pat. No. 63/281,283, filed Nov. 19, 2021; the disclosure of the brochure is incorporated by reference herein as if fully set forth. Roach is the applicant and assignee of the present application and the invention disclosed herein.

The Roach “Gator” conveyor is able to reasonably singulate the transported parcels using increasing longitudinal speed zones in a herringbone pattern to drive two lanes of transporting rollers steered towards the center line of the conveyor. A top plan view drawing illustrating the rollers and images of the underneath dual motors and pulley systems for operating the four longitudinal speed zones of the Roach “Gator” conveyor is shown in FIG. 1 and marked with “Prior Art”. While the Roach “Gator” conveyor seeks to impart a single file order for the parcels being conveyed, the parcels tend to congregate, collect and bump up against each other (hereinafter collectively “congregate” or “congregation”) toward the center line of the conveyor as the parcels are transported along the four longitudinal speed zones.

Accordingly, a need exists for a singulating conveyor which is better able to organize random parcels into a single file order with a minimum of congregation as the parcels exit at the exit end of the conveyor.

### SUMMARY OF THE INVENTION

In order to improve the “congregation” problem described above, it has been surprisingly found that providing different speeds to the opposite sides of the lateral complementary left (“L”) and right (“R”) zones (looking from the entry end) of each of the longitudinal zones of the Roach “Gator” conveyor causes the parcels to form to a better straight-line configuration. The speed differential between the L and R lateral zones work in conjunction with increasing speeds of the longitudinal zones, from the first zone at the entry end of the conveyor toward the last zone near the exit end of the conveyor. Preferably, there are four longitudinal zones 1, 2, 3 and 4 which, while working in conjunction with the L and R lateral zones , more effectively singulate the transported parcels. Each of the lateral zones L and R is preferably operated by utilizing a separate motor to each lateral zone, eight (8) motors in all counting each of the four longitudinal zones. Each motor can be controlled by its own separate variable speed controller, if desired by the user. Hence, each separate group or zone of conveying rollers, eight (8) in all, have speeds which vary both laterally and longitudinally along the conveyor. Alternatively, a pair of side-by-side motors, one for each of the L and R lateral sides, along with different ratio gearing assemblies, could be used to provide each of the eight respective longitudinal and lateral zones with the desired speed differentials.

Preferably, the singulating conveyor of the present invention includes four longitudinal zones; however, a plurality of longitudinal zones could be used starting with only two and including more than four, so long as the longitudinal zones provide increasing speeds to the respective roller zones starting with the first zone adjacent the entry end of the conveyor and continuing toward the final zone at the exit end of the conveyor.

Additionally, the speed of the final longitudinal zone is increased or decreased from the speed of its next preceding longitudinal zone based on the speed desired for the singulated parcels to exit the conveyor.

The singulating conveyor of the present invention includes a horizontal framework which supports each group of conveying rollers, as well the motors and drive systems underneath. The lateral L and R rollers are skewed toward the center in a herringbone fashion and divided into the series of longitudinal zones, which are driven in increasing speeds from the entrance end toward the exit end of the conveyor. As is conventional, the framework and rollers are supported from the floor at a desired height by reinforced stanchions.

More specifically, the singulating conveyor of the present invention includes two sets of lateral rollers at the feed end, or entrance, of the conveyor. The rollers in each zone of the conveyor are in parallel alignment, but skewed at an angle with the outer end of the rollers being forward compared to the inner end of the rollers. This skewing causes the parcels to be driven towards the center line of the conveyor. The group of rollers on the R side of the conveyor continues to the exit end, i.e., the discharge rollers, of the conveyor while maintaining the angle of the rollers. This angling of the rollers at the exit end moves the parcels from the center or center line of the conveyor to the left side (when looking down the conveyor entry or feed end). Alternatively, the conveyor can be arranged in order to move the parcels to the other side of the exit, by having the L side rollers continue to the exit, rather than the R side rollers. Generally, the lateral side of the rollers (R side or L side) which includes the exit rollers is considered to represent the “outside” lateral zones and the other side, the “inside” lateral zones.

Preferably, the rollers in each outside lateral zone operate at a selected higher speed than the rollers in its corresponding and adjacent inside lateral zone, except perhaps the last outside lateral zone that includes the discharge rollers. Further, a portion of the rollers of some outside lateral zones preferably have a higher coefficient of friction than the rollers of the corresponding and adjacent inside lateral zones. The higher coefficient of friction of the rollers in the outside lateral zones can conventionally be achieved by utilizing standard friction coverings known in the art and available commercially. A preferred conventional friction covering is ⅛ inch thick polyurethane.

The rollers are driven by a V-Belt drive system mounted underneath the rollers and supported from the horizontal framework. Each group of rollers, preferably eight (8) zones in total including two lateral zones in each of four longitudinal zones, has its own V-Belt drive system. Each of the V-Belt drive systems are set in motion by each respective separate motor (8 in total), and a gear reducer turns a drive shaft which in turn drives a drive sheave at one end of the V-belt. The V-Belt drive system includes a supporting sheave horizontally spaced from the drive sheave to support the outer end of the V-belt and intermediate pulleys underneath the drive section of the V-belt. These sheaves and pulleys provide sufficient pressure so that the upper course of the V-belt presses against the bottom of the transporting rollers to thus drive the rollers in each zone of the conveyor. The rollers are located longitudinally using vertically elongated hex holes, which allow the bottom of the transporting rollers to more easily match the upper course of the V-belt, and vertically by specially designed brackets, which limit how high the rollers can travel in the vertically elongated hex holes. Since each V-Belt drive system has a separate motor, the speed of the transporting rollers in each of the eight zones can be selected and controlled independently of each other.

Alternatively, a single pair of motors could be utilized similar to the Roach “Gator” conveyor. However, in such an arrangement, the two sheaves in each V-Belt drive system have to be individually sized in order to secure the desired speeds for each of the eight zones in a four longitudinal zone conveyor. However, once established with separately sized sheaves, the speeds established for each zone can only be somewhat varied in that a variable speed drive controller can be connected to each motor. The zone speeds on the R side will increase or decrease together by the ratios established by their corresponding sheaves. Similarly, the zone speeds on the L side will increase or decrease together by the ratios established by their corresponding sheaves. The only way to achieve greater variance is by substituting sheaves.

Accordingly, it is an object of the present invention to provide a singulating conveyor which better addresses the problem of congregation of the conveyed parcels so that the parcels form a better single-file configuration at the exit end of the conveyer.

It is another object of the present invention to provide a singulating conveyor having a plurality of longitudinal zones in a herringbone pattern with the speed of the rollers in each longitudinal zone increasing from the entrance end toward the exit end of the conveyor, while simultaneously providing different speeds to the complementary lateral L and R zones of each of the longitudinal zones.

It is a further object of the present invention to provide a singulating conveyor in accordance with the preceding object in which there are preferably four longitudinal zones of increasing speeds, thus with the different speeds of the lateral L and R zones making a total of eight different roller groups potentially having different variable speeds.

It is a further object of the present invention to provide a singulating conveyor in accordance with the preceding object in which the last longitudinal zone speed is increased or decreased to achieve the desired exit speed of the parcels.

It is a still further object of the present invention to provide a singulating conveyor in accordance with the preceding object in which each of the eight groups of rollers is driven by a separate motor and respective V-Belt drive system.

Another object of the present invention is to provide a method for operating a singulating conveyor having a plurality of longitudinal zones in a herringbone pattern in which the speed of the rollers in each longitudinal zone increases from the entrance end toward the exit end of the conveyor, while at the same time simultaneously operating the outside lateral zones at a higher speed than the rollers in the corresponding and adjacent inside lateral zones, except perhaps the last outside lateral zone that includes the discharge rollers.

Another object of the present invention is to provide a method for operating a singulating conveyor in accordance with the preceding object in which there are preferably four longitudinal zones operated at increasing speeds, thus with different speeds of the outside and inside lateral zones making a total of eight different roller groups potentially operated at different variable speeds.

Yet another object of the present invention is to provide a method for operating a singulating conveyor in accordance with the preceding object in which the outside lateral zone which includes the discharge rollers is operated at an increased or decreased speed to achieve the desired exit speed of the parcels from the conveyor.

Other objects, features, and advantages of the present invention will become apparent to those skilled in the art based upon the disclosure provided herein.

### BRIEF DESCRIPTION OF THE DRAWINGS

FIG. 1 is a top plan view of the prior art Roach “Gator” singulating conveyor showing the roller groups in side-by-side lateral zone pairs and four longitudinal zones arranged in a herringbone pattern together with images of the two motors and related drive systems mounted beneath the rollers.

FIG. 2 is a schematic top plan view of a preferred singulating conveyor in accordance with the present invention with four longitudinal zones, each divided into a pair of lateral side-by-side L ( inside) and R ( outside) zones, all arranged in a herringbone pattern and showing a random pattern of parcels entering the conveyor at the right and the parcels in a single file exiting the conveyor at the left.

FIG. 3 is a top plan view of a preferred singulating conveyor in accordance with the present invention (the Conveyor A embodiment) including four longitudinal zones of rollers and the complementary inside and outside pairs of lateral L and R zones, along with images of the eight motors and associated V-Belt drive systems operating underneath the eight variable speed zones of the conveyor.

FIG. 4 is a left side elevation view of the Conveyor A embodiment shown in FIG. 3, but without the related V-belt drive systems.

FIG. 5 is a front-end elevational end view of the singulating conveyor shown in FIG. 3.

FIG. 6 is a top view of one of the motors and related V-Belt drive system for driving seven of the eight conveying roller zones of the conveyor shown in FIG. 3.

FIG. 7 is a side elevation view of the V-Belt drive system, with the associated motor hidden for clarity, for the seven of eight roller zones shown in FIG. 6.

FIG. 8 is a side elevation view of the V-Belt drive system and associated motor similar to FIG. 7 but also includes the transporting rollers in engagement with the top side of the V-belt for driving the rollers.

FIG. 9 is a top plan view of the motor and related V-Belt drive system for the off-ramp zone of rollers at the exit end of the conveyor shown in FIG. 3.

FIG. 10 is a side elevation view of the V-Belt drive system shown in FIG. 9, with the associated motor hidden for clarity.

FIG. 11 is an enlarged view of the first and second right hand (R) longitudinal zones shown in FIG. 3.

FIG. 12 is a top plan view of another preferred singulating conveyor in accordance with the present invention (the Conveyor B embodiment) including four longitudinal zones of rollers and complementary inside and outside pairs of lateral L and R zones, along with images of the eight motors and associated V-Belt drive systems operating underneath the eight variable speed zones of the conveyor.

FIG. 13A is a left side elevational view of the Conveyor B embodiment shown in FIG. 12, but without the related V-Belt drives systems.

FIG. 13B is an enlarged side view of an upper section of the conveyor side channel shown in FIG. 13A.

FIG. 13C is an enlarged side view of one of the specially designed hold-down brackets (overlayed on the FIG. B section), which brackets limit how high the rollers can travel in vertically elongated hex holes in the Conveyor B embodiment.

FIG. 14 is a left side, front end perspective view of the Conveyor B embodiment, again showing the left side conveyor side channel and the specially designed brackets illustrated in FIGS. 13A, 13B, and 13C.

FIG. 15 is a front end elevational view of the conveyor shown in FIG. 12.

FIG. 16A is a top view of one of the motors and related V-Belt drive system for driving seven of the eight conveying roller zones of the Conveyor B embodiment shown in FIG. 12.

FIG. 16B is a side elevation view of the V-Belt drive system, with associated motor hidden for clarity, for the seven of eight roller zones shown in FIG. 16A.

FIG. 17 is a side elevational view of the V-Belt drive system for the off-ramp zone of rollers at the exit end of the conveyor shown in FIG. 12, with the associated motors hidden for clarity.

FIG. 18 is a top plan view of another preferred embodiment of a singulating conveyor in accordance with the present invention (the Conveyor C embodiment).

### DETAILED DESCRIPTION OF THE PREFERRED EMBODIMENTS

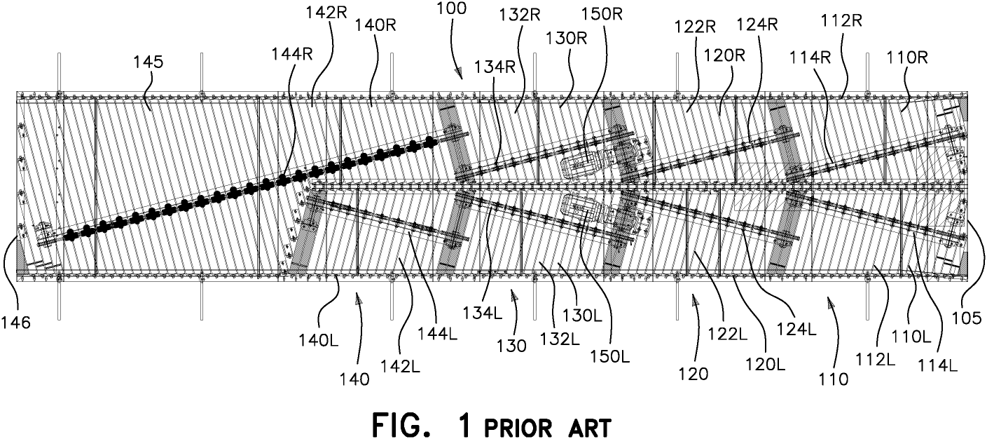

Turning first to the prior art Roach “Gator” conveyor shown in FIG. 1, the singulating conveyor is generally designated by reference number 100. The conveyor 100 is divided into four longitudinal zones, starting with the first zone 110 at the entrance or feed end 105 of the conveyor and continuing with succeeding longitudinal zones generally designated by reference numerals 120, 130 and 140, respectively. Each longitudinal zone is divided into two side-by-side inside and outside lateral zones 110 L and 110 R, 120 L and 120 R, 130 L and 130 R, and 140 L and 140 R, respectively. The left and right hand designated lateral zones are determined by looking down the conveyor from the entry or feed end 105.

Each of the eight zones 110 L, 110 R, 120 L, 120 R, 130 L, 130 R, 140 L and 140 R include a series of conveying or transporting rollers 112 L, 112 R, 122 L, 122 R, 132 L, 132 R, 142 L and 142 R, respectively. These rollers are in parallel alignment, but skewed at an angle with the outer end of the rollers being forward compared to the inner ends of the rollers. As shown, the rollers 142 R continue beyond the end of zone 140 L, at 145 and continue to the exit end 146 of the conveyor 100. This continuation of rollers 142 R causes the parcels to move from the center or center line of the conveyor to the left side at the conveyor exit end.

As shown in FIG. 1, the conveyor 100 incudes a pair of side-by-side motors 150 L and 150 R which drive eight interconnected drive systems 114 L, 114 R, 124 L, 124 R, 134 L, 134 R, 142 L and 144 R, which in turn drive the respective transporting rollers 112 L, 112 R, 122 L, 122 R, 132 L, 132 R, 142 L and 142 R. The two motors 150 and associated pulley drive systems 114, 124, 134 and 144 are configured so that the conveying rollers 112, 122, 132 and 142 are driven at successively increasing speeds across each of the four zones 110, 120, 130 and 140. However, the respective left (L) and right (R) lateral zones are driven at the same speed in each longitudinal zone.

As will be seen, there are herein disclosed three preferred embodiments of singulating conveyors in accordance with the present invention: the Conveyor A embodiment; the Conveyor B embodiment; and the Conveyor C embodiment.

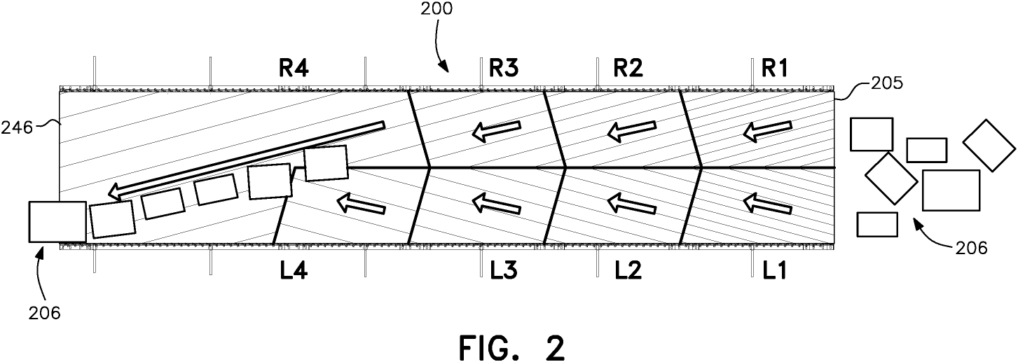

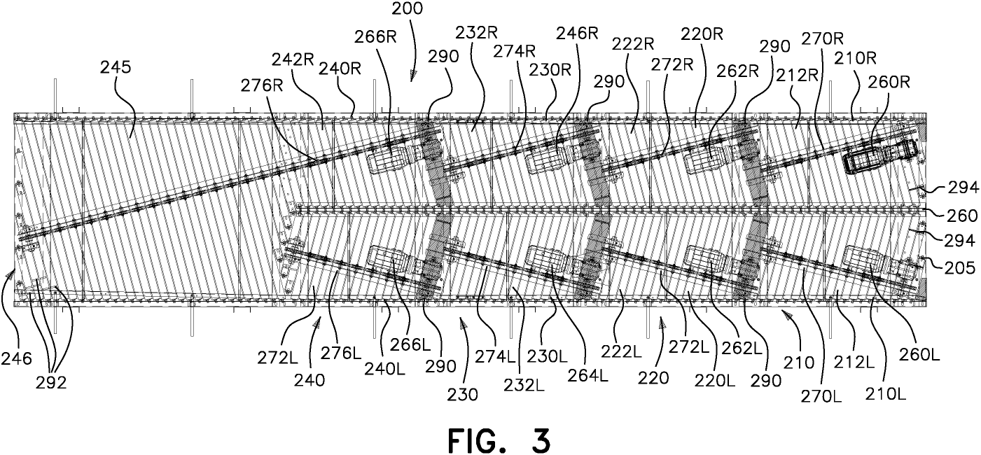

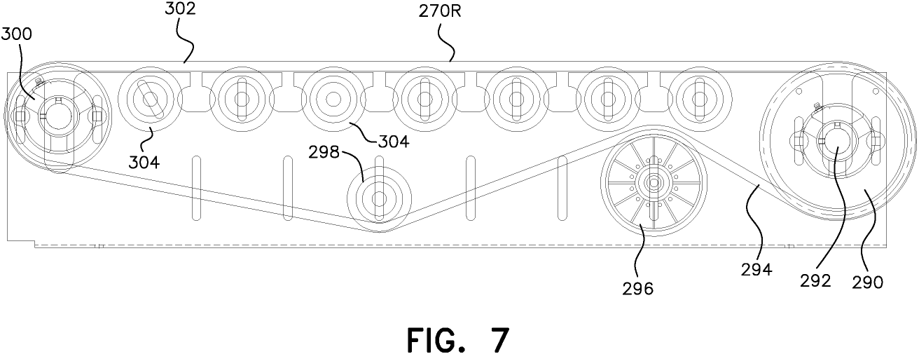

Turning now to FIG. 2, a schematic top plan view of the preferred singulating conveyors in accordance with present invention, generally designated by reference numeral 200, is shown. As shown, the singulating conveyor 200 includes four longitudinal zones, each including a pair of side-by-side lateral zones, each marked L1, L2, L3 and L4 for the left side longitudinal zones 1 through 4, and R1, R2, R3 and R4 for the right-hand side of the longitudinal zones 1 through 4. A random array of parcels, generally designated by reference numeral 206 are shown entering the entrance end 205 of conveyor 200, and the same parcels 206 are shown exiting in single file at the exit end 246 of conveyor 200. The details of the Conveyor A embodiment is described hereinafter in greater detail in connection with FIGS. 3-11.

Turning now to FIGS. 3, 4 and 5 where like components of the singulating conveyor 200 of the present invention are the same as in the singulating conveyor 100 shown in FIG. 1, the numerals are the same except the series “200” has been used instead of the series “100”. The conveyor 200 is divided into the preferred four longitudinal zones, generally designated by reference numerals 210, 220, 230 and 240, which are driven at increasing speeds from the first zone 210 at the entrance end 205 of the conveyor toward the fourth zone 240 at the exit end 246. The speed of the fourth zone 240 is increased or decreased relative to zone 230 as needed to select the desired exit speed of the parcels. While four longitudinal zones are preferred, a plurality of longitudinal zones can be used in accordance with the present invention, including only two, or more than four, so long as the longitudinal zones provide increasing speeds to the respective conveyor rollers in each zone starting with the first zone adjacent end 205 and increasing toward the final zone at exit end 246. The speed of the final zone of the plurality of longitudinal zones is increased or decreased relative to the adjacent preceding longitudinal zone as needed to select the desired exit speed of the parcels.

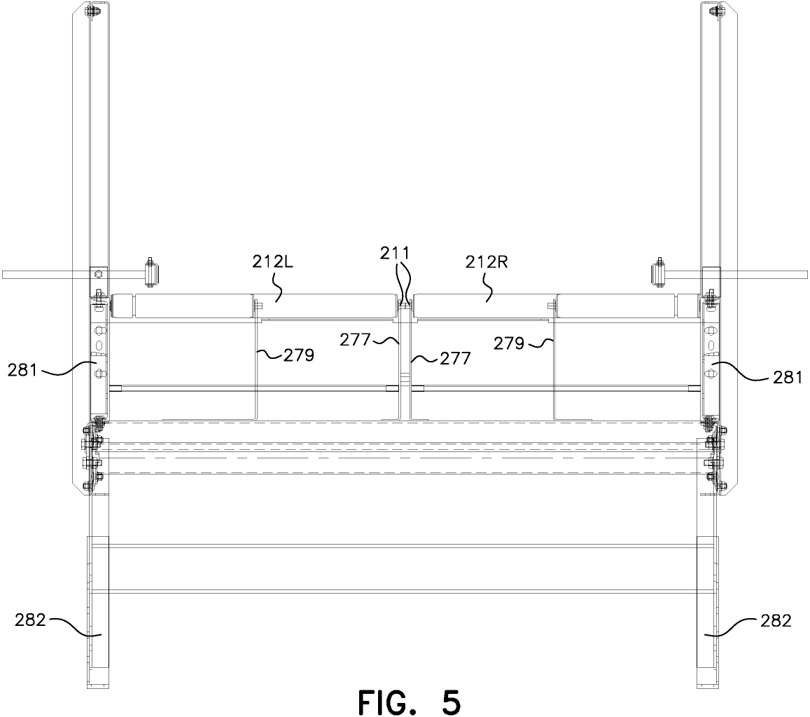

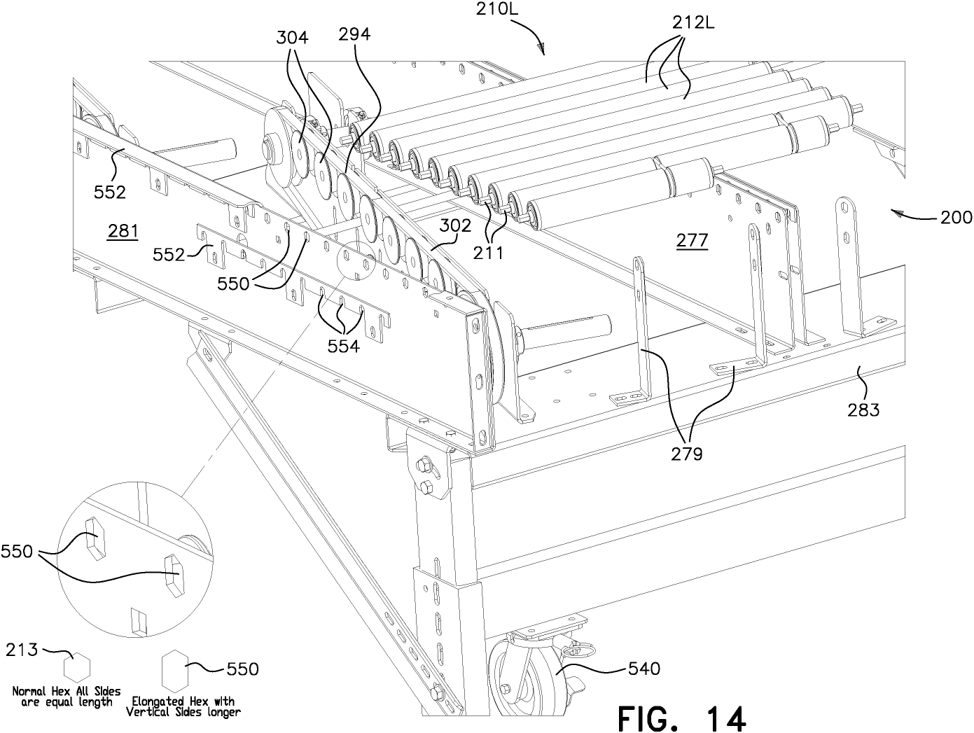

Each of the longitudinal zones incudes a pair of side-by-side lateral zones designated left (L) and right (R), thus forming four outside lateral zones 210R, 220R, 230R and 240R, and four inside lateral zones 210L, 220L, 230L and 240L. Each lateral zone of each longitudinal zone, eight (8) in total, includes a series of transporting rollers 212 L, 212 R, 222 L, 222 R, 232 L, 232 R, 242 L and 242 R. The rollers in each zone of conveyor 200 are in parallel alignment, but skewed at an angle with the outer end of the rollers being forward compared to the inner end of the rollers. The skewing causes the transported parcels to be driven towards the center line 260 of the conveyor. In a preferred configuration, the parallel rollers in each lateral zone are skewed forwardly at an angle of about 76 degrees from the center line of the conveyor, but the skewed angle can vary as much as +/- ten percent (10%). As shown FIG. 5, the rollers have conventional supporting hexagonal (hex) axles 211 which are located in corresponding mating hex holes 213 in side channels 281 (illustrated schematically in the lower left-side portion of FIG. 14) and center ribs 277 of the framework 280, except the shortened rollers at various locations along the conveyor, which have one axle end supported by L-brackets 279 (see FIG. 5, for example, at the front end of the conveyor). The shortened rollers can be seen in FIG. 3 at the front end of the conveyor, the rear end of the conveyor and about midway in zone 240.

As shown in FIG. 3, the group of rollers 242 R extend beyond the end of the zone 240 L, i.e., the discharge rollers 245, and the discharge rollers 245 continue to the exit end of the conveyor while maintaining the roller angle. This angling of the rollers at the exit end moves the parcels from the center or center line of the conveyor to the left side. If desired to have the parcels exit to the right-hand side of the conveyor, the length of zones 240 L and 240 R can be reversed so that rollers 242 L extend to the exit end 246 of the conveyor, and the rollers 242 R will terminate where the rollers 242 L are shown terminating in FIG. 3.

In the embodiment shown in FIG. 3, the lateral zones on the R side of the conveyor which includes discharge rollers 245 at the exit end 246 are considered the outside lateral zones and the lateral rollers on the L side of the conveyor are considered the inside lateral zones. If the exit end 246 were reversed to include the lateral zone 242 L, then the lateral zones on the L side of the conveyor would be considered the outer lateral zones and the lateral zones on the R side of the conveyor would be considered the inner lateral zones.

In accordance with the present invention, the conveyor 200 is designed so that the transporting rollers in each of the eight lateral and longitudinal zones can be driven independently and separately at variable and different speeds. Surprisingly, if the opposite sides of the lateral complementary left (L) and right (R) zones of each longitudinal zone is provided with different speeds, the parcels conveyed by the conveyor 200 form a better straight-line configuration at the exit end 246. To this end, each of the eight zones is provided with separate motors 260 L and 260 R for zone 210, 262 L and 262 R for zone 220, 264 L and 264 R for zone 230 and 266 L and 266 R for zone 240. Each of the motors 260 L and R, 262 L and R, 264 L and R, and 266 L and R drive separate and individual V-Belt drive systems 270 L and R, 272 L and R, 274 L and R and 276 L and R, respectively. Each of the eight motors are the same and seven of the V-Belt drive systems 270 L and R, 272 L and R, 274 L and R, 276 L and R are the same. Drive system 276 R is extended beyond zone 240 L and continues to the exit end 246 of the conveyor 200, as shown by discharge rollers 245, so that the parcels exit on the left side (or inner side) of conveyor 200.

Preferably, the rollers 212 R, 222 R, 232 R and 242 R of each of the outside lateral zones are driven at a selected faster speed than the corresponding rollers 212 L, 222 L, 232 L and 242 L of each of the adjacent inside lateral zones. Further, the coefficient of friction for a portion of the rollers in a plurality of the outside lateral zones is greater than that for the rollers in the corresponding and adjacent inside lateral zones. This higher coefficient of friction can be achieved by covering at least some of the rollers in the outside lateral zones with standard ⅛ inch thick friction polyurethane coverings which are available commercially from Spiratex of Romulus, Michigan. Similar polyurethane roller sleeves are available from Kastalon Polyurethane Products of Alsip, Illinois, and conveyor roller covers and coatings are available from C & M Coatings, Inc of Grand Haven, Michigan.

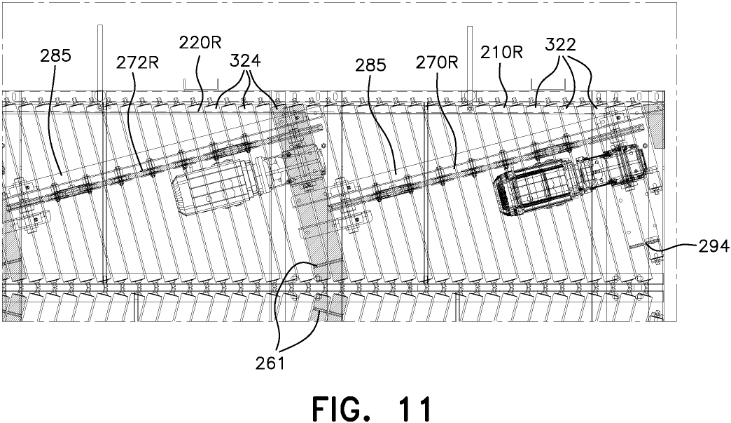

Further, there are a few of the transporting rollers in each zone where the V-Belt drive system cannot contact the rollers. In such circumstances, the rollers are connected by bands 261 to provide for their rolling action. The bands (dark lines) can be seen in FIG. 3 in each of the shaded areas marked with the numeral 290 (near the center line 260), along with bands 292 at the lower far left of the conveyor and bands 294 at the center far right of the conveyor. The bands 261 and 294 are best seen in FIG. 11.

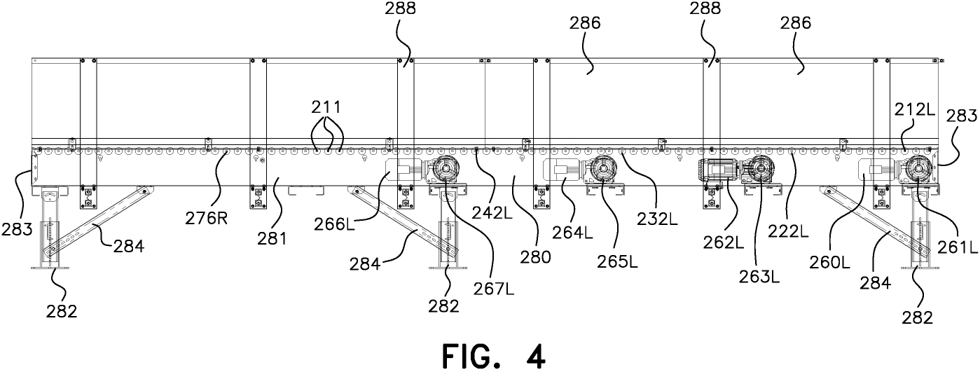

The transporting rollers and motors 260L, 262L, 264L and 266L are mounted on a horizontal framework 280 as shown in FIG. 4. The framework 280 includes side channels 281 on each of the left and right sides of the conveyor (see FIG. 5) and end channels 283 at the front and back ends of the conveyor. Although not shown in FIG. 4, the framework 280 also supports the V-Belt drive systems 270 L and R, 272 L and R, 274 L and R and 276 L and R. The framework 280, as well as the rollers, motors, and drive systems, is supported from the floor at a desired height by reinforced stanchions 282 and angle braces 284. Extending upperwardly from the side channels 281 along each side of the framework 280 are a series of side panels 286. The side panels 286 extend along the full length of the conveyor 200 and are supported by vertical support brackets 288.

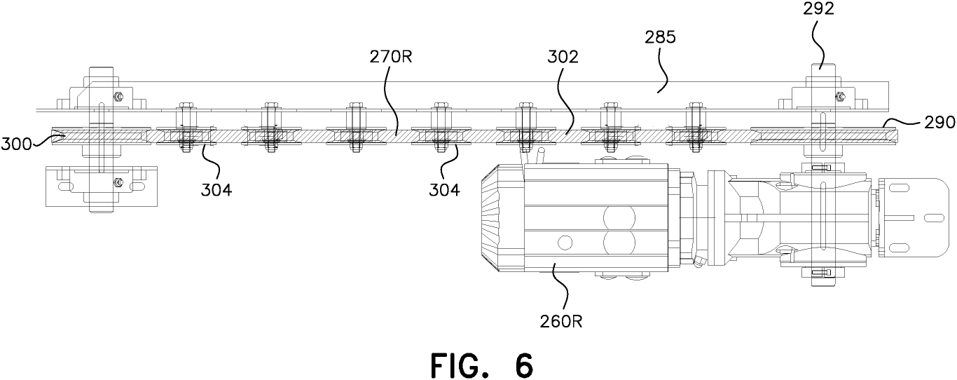

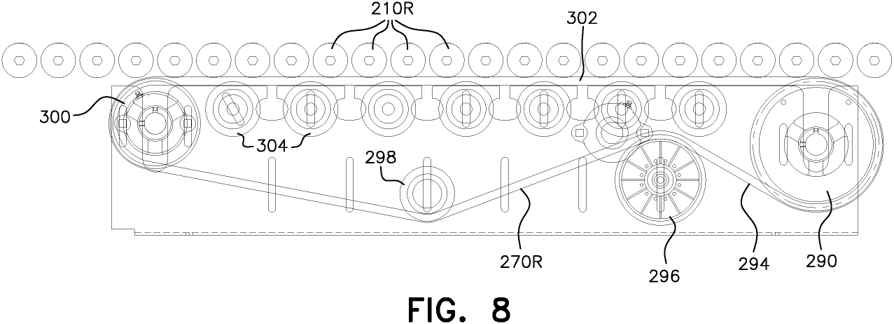

Turning next to FIGS. 6, 7 and 8, a representative motor 260 R and associated V-Belt drive system 270 R are shown as illustrative of the seven zones 210 L and R, 220 L and R, 230 L and R and 240 L. Motor 260 R is connected to a gear reducer which drives shaft 292. Drive sheave 290 is mounted on drive shaft 292. A V-belt 294 is engaged around drive sheave 290 and extends around horizontally spaced support sheave 300. The V-belt 294 also extends over tension pulley 296 and underneath tension pulley 298. The upper horizontal extent 302 of V-belt 294 between drive sheave 290 and support sheave 300 is supported by a series of intermediate pulleys 304. As shown in FIG. 8, the upper surface of the V-belt horizonal extent 302 is pressed up against the lower surface of transporting rollers 210 R. As such, the V-belt is squeezed between the drive and supporting sheaves and the rollers so that when the V-belt is in motion, the friction between the V-belt and the rollers causes the transporting rollers to turn. Other drive systems besides this specific V-Belt drive system disclosed herein could be utilized without the departing from the present invention.

As shown in FIGS. 4 and 6, the motors 260L, 262L, 264L and 266L are supported on motorbases 261L, 263L, 265L and 267L, respectively. The V-Belt drive system 270R is supported on the sheave support angle 285 of the framework 280. In the Conveyor A embodiment (as shown in FIG. 6), the V-Belt drive system 270R is positioned between the motor 260R and the sheave support angle 285.

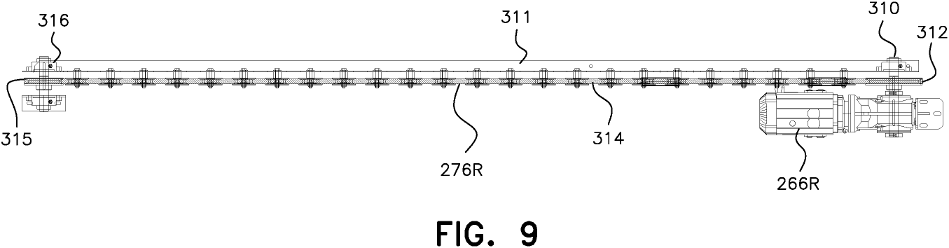

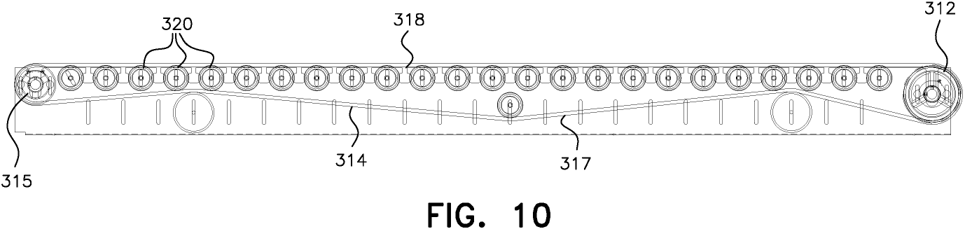

The motor 266 R and associated drive system 276 R for zone 240 R are shown separately in FIGS. 9 and 10. The drive system 276R is similarly supported on sheave support angle 311 between the motor 266R and the sheave support angle 311. The motor 266 R is connected to a gear reducer which drives shaft 310. Drive sheave 312 is mounted on drive shaft 310 and engages the V-belt 314. V-belt 314 extends around horizontally spaced support sheave 315 which is mounted adjacent the exit end 246 of the conveyor 200 by bracket 316. The lower portion 317 of the V-belt 314 also extends over and under tension pulleys similar to that described for V-belt 294 in FIGS. 6, 7 and 8. The upper horizontal extent 318 of the V-belt 314 between drive sheave 312 and support sheave 315 is also supported by a series by an intermediate pulleys 320. The upper surface of the horizonal extent 318 of V-belt 314 also engages the under surface of the transporting rollers 242 R and 245 of zone 240 R in the same manner as described and illustrated in connection with FIG. 8.

Next, turning to FIG. 11, an enlarged view of zones 210 R and 220 R, taken from FIG. 3 is shown. More specifically, it has been found that singulation of the parcels can be enhanced if some of the rollers have a friction enhancing covering applied to their outer surface, as previously described. This is particularly advantageous for rollers in the outer lateral zones of the first and second longitudinal zones as shown for the Conveyor A embodiment, which zones have a higher speed relative to that zone’s mating inner lateral zone. Hence for the Conveyor A embodiment described herein, the friction covering is preferably applied to a portion of rollers 210 R and 220 R. While not intended to be bound by specific rollers, it has been found that applying a frictional covering to the three rollers 322 in zone 210 R and the three rollers 324 in zone 220 R, is beneficial to singulating the parcels by conveyor 200 as described herein. More recently, it has been found that the friction covering can preferably be applied to a portion of rollers 210R, 220R, and 230R, as hereinafter described in connection with the Conveyor B embodiment. By applying frictional coverings to four rollers in zone 210R, four rollers in zone 220R and four rollers in zone 230R, a more beneficial singulation of the parcels may be achieved.

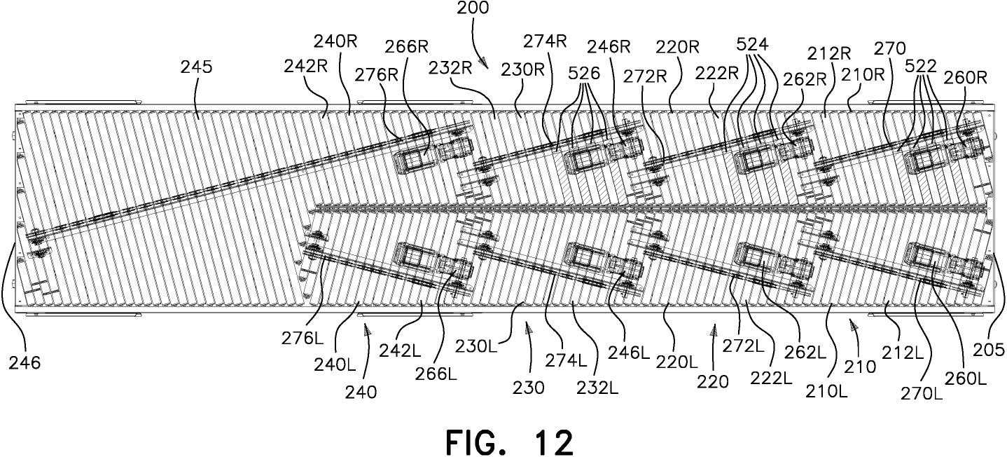

Turning now to the singulating conveyor shown in FIGS. 12-16, the Conveyor B embodiment, it will be apparent to those skilled in the art that most of the components and the operation of the Conveyor B embodiment are the same as previously described in connection with the Conveyor A embodiment illustrated in FIGS. 3-11. Accordingly, the numerals used in FIGS. 12-16 for the Conveyor B embodiment will follow those of the “200” and “300”series, and only those components which are different in the Conveyor B embodiment will be identified by the “500” series.

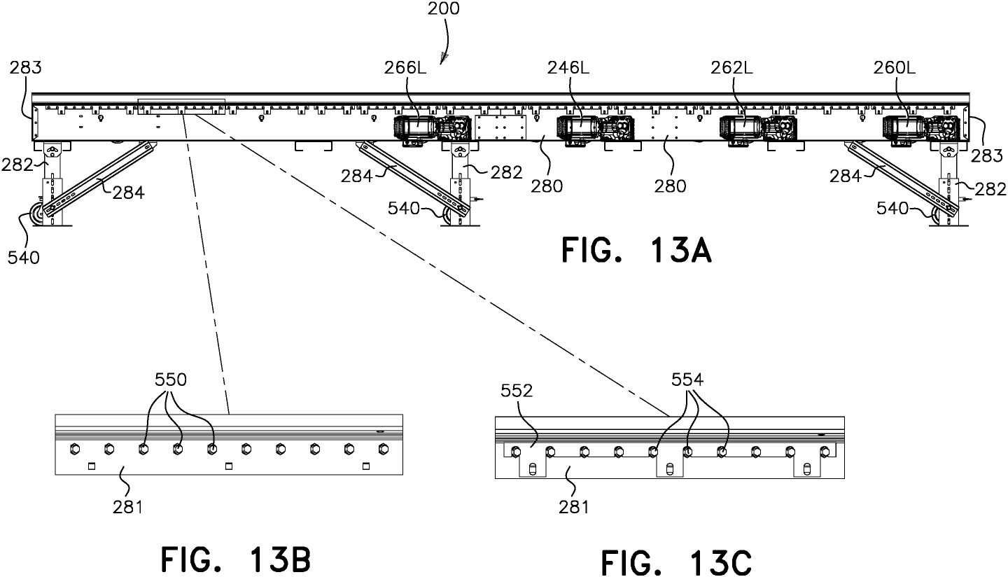

The differences between the Conveyor B embodiment and the Conveyor A are as follows:
(1) the Conveyor B embodiment utilizes frictional coverings on four rollers of each of the first three outer lateral zones, whereas the Conveyor A embodiment utilizes frictional coverings on only three rollers of the first two outer lateral zones;
(2) the Conveyor B embodiment does not include the side panels 286 and vertical support brackets 286 of the Conveyor A embodiment;
(3) the Conveyor B embodiment includes standard swivel caster wheels routinely used in the conveyor industry, which facilitate movement of the Conveyor B embodiment;
(4) All of the V-Belt drive systems of the Conveyor B embodiment are supported on the outside of their respective sheave support angles, rather than between the sheave support angle and the adjacent motor as in the Conveyor A embodiment, in order to make adjustment easier if needed on the sheaves.
(5) the V-Belt drive system for the off-ramp zone of the discharge rollers at the exit end of the Conveyor B embodiment has a slightly different arrangement for the drive sheave, and the engaged V-belt drive traverses a slightly different path; and
(6) the roller axles of the Conveyor B embodiment are supported in vertically elongated hex holes and their vertical movement is limited by specially designed brackets, illustrated specifically in FIGS. 13C and 14.

### Frictional Coverings in the Conveyor B Embodiment

The frictional coverings in the Conveyor B embodiment are shown as shaded rollers in FIG. 12. As can be seen, there are frictional coverings applied to four rollers 522 in zone 210R, four rollers 524 in zone 222R, and four rollers 526 in zone 230R.

### No Side-Panels in the Conveyor B Embodiment

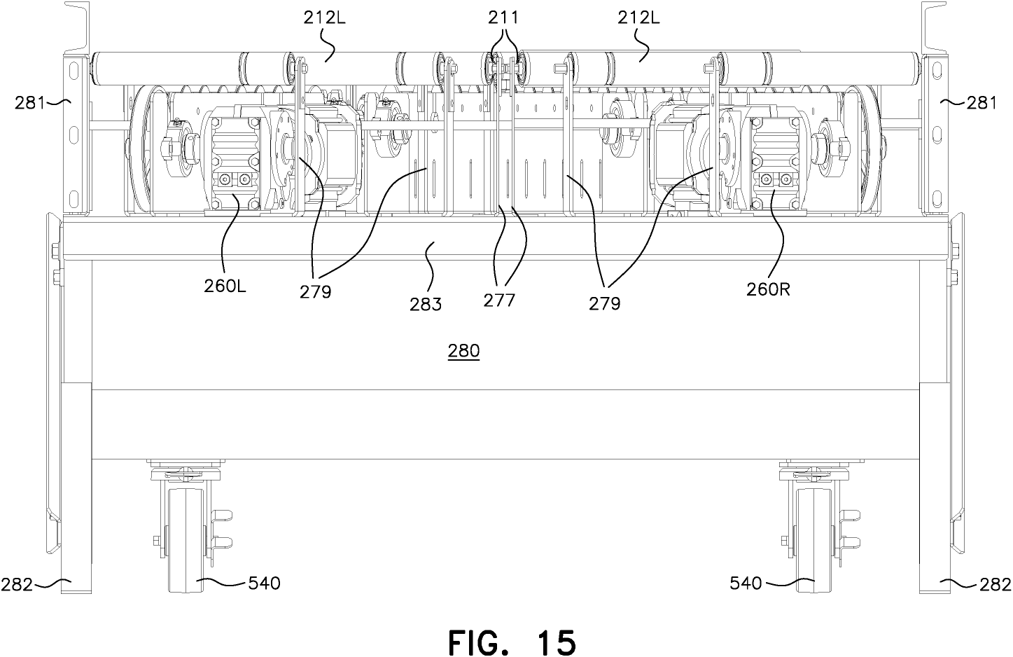

As can be seen from FIGS. 13A and 15, there are no side panels 286 extending upwardly from the side channels 281, or the vertical support brackets 288, in the Conveyor B embodiment.

### Standard Swivel Caster Wheels in the Conveyor B Embodiment

As shown in FIGS. 13A, 14 and 15, the Conveyor B embodiment includes standard swivel caster wheels 540, which allow the Conveyor B embodiment to be easily moved from one location to another.

### V-Belt Drive Systems for the Conveyor B Embodiment

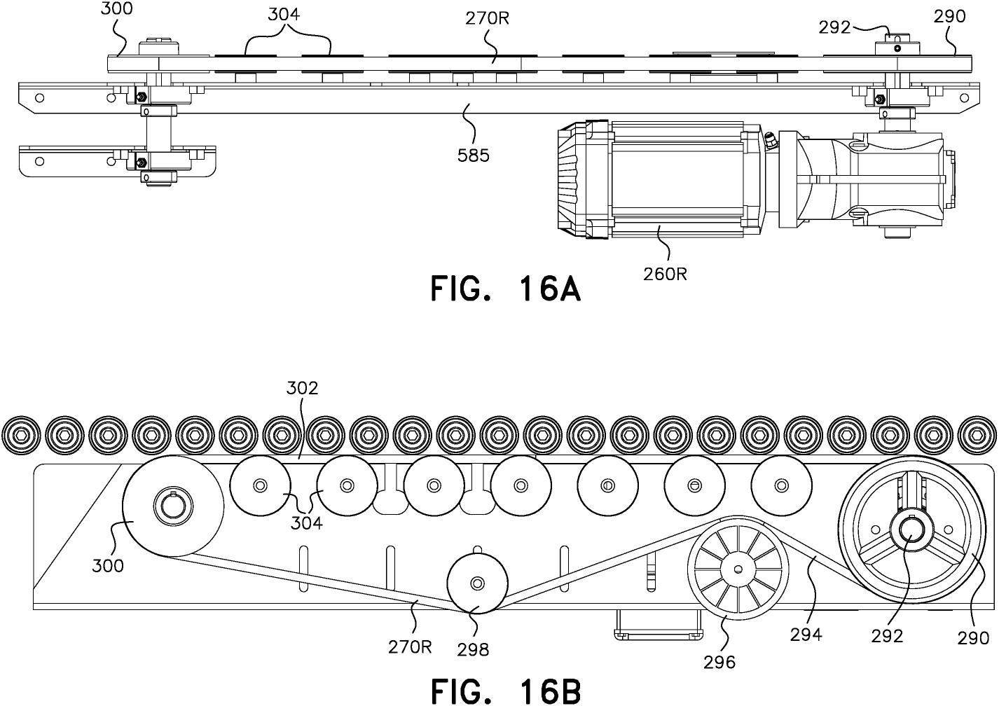

The representative motor 260R and associated V-Belt 270R for the seven zones 210L and 210R, 220L and 220R, 230L and 230R and 240L of the Conveyor B embodiment are shown in FIGS. 16A and 16B. As shown, the V-Belt drive system 270R is mounted on the opposite side (outside) of the sheave support angle 585 from the motor 260R, thus facilitating easier service and repair of the V-Belt drive system 270R. Otherwise, the components of the motors and V-Belt drive systems are the same or equivalent in both the Conveyor A embodiment and the Conveyor B embodiment.

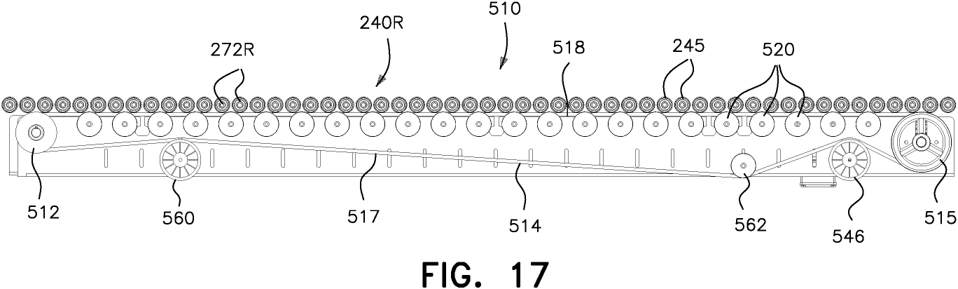

As shown in FIG. 17, the V-Belt drive system for the off-ramp zone 240R of the discharge rollers at the exit end of the Conveyor B embodiment is generally designated by reference numeral 510, and includes V-belt 514. V-belt 514 is driven by draft sheave 512, and its lower extent 517 extends over, under and over three tension spools 560, 562, and 564, respectively, and around horizontally spaced support sheave 515 which is mounted adjacent the exit end 246 of the conveyor 200. The upper horizontal extent 518 of the V-belt 514 between drive sheave 512 and support sheave 515 is also supported by a series of intermediate pulleys 520. The upper surface of the horizontal extent 518 also engages the under surface of the transporting rollers 242R and 245 of zone 240R in the same manner as described and illustrated in connection with the Conveyor A embodiment.

### Vertically Elongated Hex Holes and Specially Designed Brackets for the Conveyor B Embodiment

As shown in FIG. 14, the front end of side channel 281 on the left hand side of the conveyor 200 is shown as supported on the stanchion 282 and angle brace 284. Transporting rollers 212L of the first inner lateral zone 210L are shown and include hex axles 211 with their inner ends supported on center rib 277 and L-brackets 279. The outer ends of hex axles 211 extend above pulleys 304, the extent 302 of V-belt 294 and are then received in the vertically elongated hex holes 550 along the upper edge of the side channel 281. Two of the specially designed hold down brackets 552 are shown, one in position on the side channel 281 and one spaced away to show the position of the hex holes 550. See also FIGS. 13A, B and C. The enlarged vertical characteristic of the hex holes is illustrated in the cut out drawing shown in the lower left-side portion of FIG. 14.

As will be appreciated by those skilled in art, the elongation of the hex holes 550 allows the surface of the transporting rollers in each zone to lay on top of the respective V-belt. The axle shaft 211 of the roller, and the roller itself, is limited vertically in the down direction by the roller being in contact with the V-belt and vertically in the up direction by the notches 554 in the bracket 552.

The following description of roller speeds and roller speed ratios applies equally with respect to conveyor 200 of both the Conveyor A embodiment and the Conveyor B embodiment.

It has been found that the speed of the conveyor 200, and each of the individual eight zones, can be varied depending on the particular application and the parcels to be conveyed and singulated thereby. The zone with the lowest roller speed is zone 210 L and can range from as low as 50 ft. per minute to as high as 150 ft. per minute. Preferably, the speed of the rollers 212 L in zone 210 L are typically set at 131 ft. per minute. Once the speed of the rollers 212 L in zone 210 L is established, there has been success in setting the rollers in the other zones to have speeds according to the following sets of ratios:

| | |
|---|---|
| Ratio Set A | Ratio Set B |
| Zone 210 R = 2.18 times zone 210 L | Zone 210 R = 2.37 times zone 210 L |
| Zone 220 R = 1.97 times zone 220 L | Zone 220 R = 2.46 times zone 220 L |
| Zone 230 R = 1.48 times zone 230 L | Zone 230 R = 1.86 times zone 230 L |
| Zone 240 R = 1.26 times zone 240 L | Zone 240 R = 1.08 times zone 240 L |

In addition to the above, the average speed for each of the 4 longitudinal zones change in ratios and should be in accordance with the following:

Ratio Set A
Average of Zones 220 L and R = 1.31 times the average of zones 210 L and R
Average of Zones 230 L and R = 1.28 times the average of zones 220 L and R
Average of Zones 240 L and R = 1.09 times the average of zones 230 L and R

Ratio Set B
Average of Zones 220 L and R = 1.15 times the average of zones 210 L and R
Average of Zones 230 L and R = 1.17 times the average of zones 220 L and R
Average of Zones 240 L and R = 0.83 times the average of zones 230 L and R

In addition to the foregoing preferred speed ratios for the various zones, it is contemplated that the speed ratios can vary +/- twenty percent (20%).

Again, the above description and data for roller speed and ratios is set forth for conveyor 200 and applies equally to the Conveyor A embodiment, and the Conveyor B embodiment.

While two preferred embodiment of the present invention have been described in detail in connection with conveyor 200, i.e., the Conveyor A embodiment and the Conveyor B embodiment, it is also possible to achieve the same variable speeds of the eight lateral and longitudinal zones by varying the size of the sheaves which support the V-belts that drive the transporting rollers in each of the eight zones. This alternate preferred embodiment is illustrated in FIG. 17.

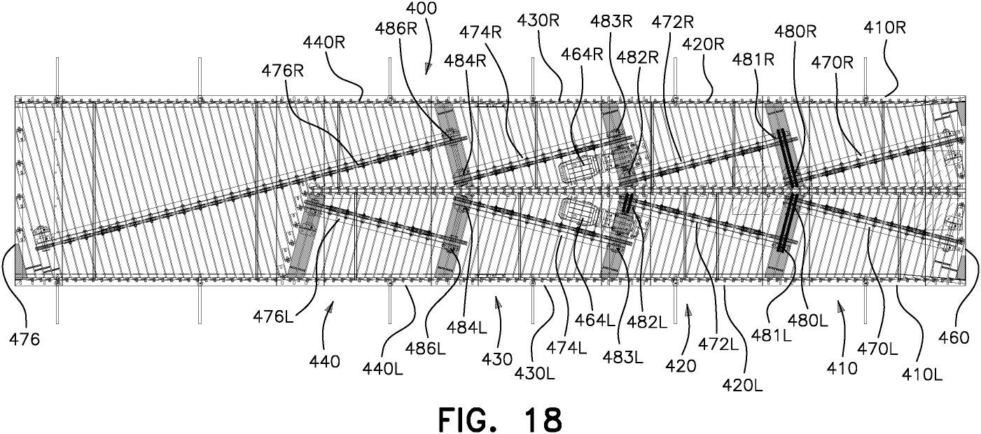

As shown in FIG. 18, the Conveyor C embodiment is generally designated by reference numeral 400 and includes four longitudinal zones, generally designated by reference numerals 410, 420, 430 and 440, each of which includes right and left lateral zones 410 L and 410 R, 420 L and 420 R, and 430 L and 430 R, and 440 L and 440 R, respectively, starting at the entry end 460 of the conveyor and terminating at the exit end 446. Singulating conveyor 400, however, includes only two motors, a left-hand motor 464 L which drives four interconnected V-Belt drive systems, including drive system 470 L in zone 410, drive system 472 L in zone 420, drive system 474 L in zone 430 and drive system 476 L in zone 440, as shown by interconnecting shafts. Conveyor 400 additionally includes a right hand motor 464 R which drives four interconnected V-Belt drive systems, including drive system470 R in zone 410, drive system 472 R in zone 420, drive system 474 R in zone 430 and drive system and 476 R in zone 440, as shown by interconnecting shafts. The relevant sheaves are sheaves 480 L and 480 R in zone 410, sheaves 481 L and 481 R and 482 L and 482 R in zone 420, sheaves 483 L and 483 R and 484 L and 484 R in zone 430, and sheaves 486 L and 486 R in zone 440.

In order to accomplish the speed ratios outlined above for conveyors 200, it is believed that the sheave diameters for conveyor 400 should be arranged in the following ratios:

| | |
|---|---|
| Ratio Set A | Ratio Set B |
| Sheave 481 L = 1.40 times sheave 480 L | Sheave 481 L = 1.12 times sheave 480 L |
| Sheave 483 L = 1.53 times sheave 482 L | Sheave 483 L = 1.42 times sheave 482 L |
| Sheave 486 L = 1.20 times sheave 484 L | Sheave 486 L = 1.14 times sheave 484 L |
| Sheave 481 R = 1.27 times sheave 480 R | Sheave 481 R = 1.16 times sheave 480 R |
| Sheave 483 R = 1.15 times sheave 482 R | Sheave 483 R = 1.07 times sheave 482 R |
| Sheave 486 R = 1.02 times sheave 484 R | Sheave 486 R = 0.66 times sheave 484 R |

In addition to the foregoing preferred sheave diameter ratios for the various V-Belt drive systems, it is contemplated that the diameter ratios can vary +/- ten percent (10%).

The preferred embodiments of the present invention have been described in detail in connection with conveyors 200 and 400 having the parcels exit on the left hand side of the conveyor. If it is desired to have the parcels exit to the right hand side of the conveyors, the speed ratios mentioned before should be swapped between L and R.

The method for operating a singulating conveyor in accordance with the present invention should be evident to those skilled in the art based upon the foregoing descriptions and related drawing figures. For example, the Conveyor B embodiment illustrated in FIGS. 12-17 is operated with a selected speed of the transporting rollers in each longitudinal zone increasing sequentially from the entrance end of the conveyor to the exit end of the conveyor, while at the same time simultaneously operating the outer lateral zones at a selected higher speed than the transporting rollers in the corresponding and adjacent inner lateral zones, except perhaps the outer lateral zone that includes the discharge rollers 245. The outer lateral zone which includes discharge rollers 245 is operated at an increased or decreased speed to achieve the selected exit speed of the parcels from the conveyor. The Conveyor A embodiment is operated in a similar fashion as described with respect to the Conveyor B embodiment, and the Conveyor C embodiment is also operated in a similar fashion.

The foregoing is considered as illustrative of the principles of the invention. Further, numerous modifications and changes will readily occur to those skilled in the art. As such, it is not desired to limit the invention to the exact construction and operation shown and described; all suitable modifications and equivalents may be resorted to falling within the scope of the invention.

What is claimed is:

1. A singulating conveyor comprising:
transporting rollers extending from an entry end of the conveyor to an exit end of the conveyor and divided into a plurality of longitudinal zones;
the transporting rollers of each longitudinal zone divided at a longitudinal center line of the conveyor into a pair of side-by-side complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern; and
said longitudinal zones and said lateral zones operated at selected speeds to singulate and transport a random flow of parcels at said entrance end of the conveyor to said exit end of the conveyor.

2. The singulating conveyor in accordance with claim 1, wherein the transporting rollers are divided into four longitudinal zones thus a total of eight zones.

3. The singulating conveyor in accordance with claim 1, wherein the transporting rollers of each lateral zone of the complementary pair is operated at a different speed, and the speed of the transporting rollers in said plurality of longitudinal zones successively increases from the longitudinal zone adjacent the entry end of the conveyer toward the longitudinal zone having discharge rollers at the exit end of the conveyor.

4. The singulating conveyor in accordance with claim 3, wherein a separate motor and drive system operates the transporting rollers of each lateral zone in each of the said plurality of longitudinal zones, making a total of eight zones and eight separate motors and drive systems.

5. The singulating conveyor in accordance with claim 1, wherein at least some of the transporting rollers in the outside lateral zones of a plurality of the longitudinal zones have a higher coefficient of friction than the transporting rollers of their corresponding and adjacent inside lateral zones.

6. The singulating conveyor in accordance with claim 1, wherein each of the eight zones can be operated at different and variable speeds.

7. The singulating conveyor in accordance with claim 2, wherein there are only two motors, one for each pair of four longitudinally aligned outside and inside lateral zones, each motor is connected to and drives four interconnected drive systems, one for each of the two longitudinally aligned four lateral zones, each drive system separately sized to operate and drive the transporting rollers of the lateral and longitudinal zones at different speeds.

8. The singulating conveyor in accordance with claim 3, wherein the transporting rollers of the outside lateral zone having the discharge rollers extends beyond its complementary inside lateral zone so that the parcels exit the conveyor at the side of said inside lateral zone.

9. The singulating conveyor in accordance with claim 6, wherein the transporting rollers of the outside lateral zone adjacent the exit end of the conveyor extends beyond the complementary inside lateral zone so that the parcels exit the conveyor at the side of said complementary inside lateral zone.

10. The singulating conveyor in accordance with claim 9, wherein said transporting rollers, said eight separate motors and drive systems are supported from a horizonal framework.

11. The singulating conveyor in accordance with claim 6, wherein said drive systems are each V-Belt drive systems.

12. The singulating conveyor in accordance with claim 3, wherein the transporting rollers of each outside lateral zone of the complementary pair is operated at a higher speed than the corresponding inside zone, except the outside lateral zone having the exit rollers can be operated at a selected higher or lower speed than its complementary inside lateral zone.

13. The singulating conveyor in accordance with claim 2, wherein at least three of the transporting rollers in the outside lateral zones closest to the entry end of the conveyor have a higher coefficient of friction than the corresponding rollers of the complementary and adjacent inside lateral zones.

14. A method for operating a singulating conveyor including transporting rollers extending from an entry end of the conveyor to an exit end of the conveyor and divided into a plurality of longitudinal zones, the transporting rollers of each longitudinally zone divided at a longitudinal center line of the conveyor into a pair of sidebyside complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern, and the outside lateral zone adjacent the exit end of the conveyor includes discharge rollers which extend beyond the complementary and adjacent inside lateral zone;
said method comprising operating said longitudinal zones and said lateral zones at selected speeds to singulate and transport a random flow of parcels from said entrance end of the conveyor to said exit end of the conveyor.

15. The method for operating a singulating conveyor in accordance with claim 14, wherein each of the outside lateral zones is operated at a higher speed than its corresponding and adjacent inside lateral zone, except the outside lateral zone having the exit rollers can be operated at a selected higher or lower speed than its complementary and adjacent inside lateral zone.

16. The method for operating a singulating conveyor in accordance with claim 14, wherein at least some of the transporting rollers in the outside lateral zone of a plurality of the longitudinal zones operate at a higher coefficient of friction than the complementary and adjacent inside lateral zones.

17. A singulating conveyor comprising:
transporting rollers extending from an entry end of the conveyor to an exit end of the conveyor and divided into a plurality of longitudinal zones;
the transporting rollers of each longitudinal zone divided into a pair of side-by-side complementary outside and inside lateral zones, said transporting rollers of each lateral zone skewed at an angle with an outer end of the rollers being forward compared to an inner end of the rollers so that said longitudinal zones and said lateral zones are arranged in a herringbone pattern; and
some of the transporting rollers of at least two of said outside lateral zones having a higher coefficient of friction than its complementary and adjacent inside lateral zone.

18. The singulating conveyor in accordance with claim 17, wherein the speed of the transporting rollers in said plurality of longitudinal zones successively increases from the longitudinal zone adjacent the entry end of the conveyor towards the longitudinal zone having rollers at the exit end of the conveyor.

19. The singulating conveyor in accordance with claim 18, wherein the transporting rollers of each outside lateral zone is operated at a higher speed than its complementary and adjacent inside lateral zone, except the outside lateral zone having exit rollers which can operate at a higher, lower or equal speed to its complementary and adjacent inside lateral zone.

20. The singulating conveyor in accordance with claim 17, wherein the transporting rollers are divided into four longitudinal zones and two lateral zones, thus a total of eight zones, and a separate motor and drive system operates the transporting rollers of each lateral zone in each of the four longitudinal zones.

21. The method for operating a singulating conveyor in accordance with claim 16, wherein the higher coefficient of friction for the transportation rollers in the outside lateral zones is achieved by applying a friction covering to said rollers.

22. The singulating conveyor in accordance with claim 17, wherein said transporting rollers with a higher coefficient of friction have a friction covering.

23. The singularity conveyor in accordance with claim 17, wherein said higher coefficient of friction for some of the transporting rollers of at least two of the outside lateral zones serves to better singulate a random flow of parcels at said entrance end of the conveyor to said exit end of the conveyor than a conveyor having transporting rollers with a lesser coefficient of friction.
